(19) United States
(12) Patent Application Publication
(10) Pub. No.: US 2023/0342836 A1
(43) Pub. Date: Oct. 26, 2023

(54) Enhanced Method and Apparatus for An Electronic Interactive Presentation

(71) Applicant: Mohammad Izadpanah, Miami, FL (US)

(72) Inventor: Mohammad Izadpanah, Miami, FL (US)

(21) Appl. No.: 17/727,959

(22) Filed: Apr. 25, 2022

(51) Int. Cl. G06Q 30/06

(52) U.S. Cl. CPC G06Q 30/0641

(57) ABSTRACT

Disclosed is a device for making an electronic interactive presentation to a user. The device includes a central processing unit (CPU) for executing a computer program and a database for storing data to be retrieved by CPU for presentation to the user upon the user's request.

### CROSS-REFERENCE TO RELATED APPLICATION

This application claims priority to Application Ser. No. 63/178,722 filed Apr. 23, 2021 and entitled Enhanced Method and Apparatus for An Electronic Interactive Presentation, such application is fully incorporated herein by reference.

### TECHNICAL FIELD

The present invention generally relates to the field of information technology and more particularly, is directed to a method and apparatus for an electronic interactive presentation.

### BACKGROUND OF THE INVENTION

As broadly defined, interactive presentations are not new and include, for example, a lecturer discussing a particular subject with questions and comments from the audience. Interactive presentations can also be electronic by allowing the participant to interact with the presentation by using click buttons, hotspots, navigation links and the like. Such electronic presentations allow participants to, depending upon the presentation, adapt the presentation to suit their particular needs and interest.

As electronic communication methods and systems continue to improve, become more robust, cost effective and more generally available to the masses, so too does the desirability and practicality of presenting more detailed and complex information to the consuming public in a way that is more easily tailored a particular consumer's needs. Thus, electronic presentations are beginning to play a more important role in everyday life in the way of online services.

While the Covid-19 virus pandemic and the need to limit travel has contributed to more people using online services, the trend was present long before Covid-19. The trend follows evolving consumer preferences to conduct as many of the affairs of life remotely using electronic means rather than through in-person engagements.

The sectors of the economy that do not involve physical product attributes that a consumer must consider when making a purchase decision lessens the need for in-person engagements, or greatly diminished such a need.

For example, industry reports suggest that consumer visits to retail banks will continue to drop substantially in the coming years. Banking services do not have physical attributes that a consumer must consider before make a purchase decision.

On-line shopping is also expected to continue to increase as well as mobile and desktop devices become the consumer's primary mode of contact. While on-line shopping most often involves the purchase of physical products, the shopper is typically already knowledgeable about the physical attributes of the produce based on prior experience or the cost of the product is sufficiently low that the risk of an errant purchase is low. Staple products fall into this category.

On the other hand, sectors that involve the purchase of high value hard goods where physical characteristic are important have not heretofore been on-line friendly. While some product research can be done online, it has been customary for consumers to visit a brick-and-mortar location to see and inspect the actual product before making a purchase decision. This is especially true for products that are high in cost or where the purchase decision is driven at least in part by the presence of an affinity for the particular product. Nevertheless, visits to brick-and-mortar establishments have declined in recent years.

This trending decline is being felt across many industries, such as automobiles, boats, recreational vehicles, motorcycles, jets, etc. For example, as the demand for relevant, easy-to-consume information about cars and other vehicles continues to soar among today's increasingly internet-savvy car shoppers, auto dealers are aggressively searching for the most impactful online solutions to add to their marketing arsenals.

Thus, there is a need in the art for an improved method and apparatus to address the needs of consumer and retailers with respect to making purchasing decisions based on the consumer's online experience. The present invention provides such a method and apparatus.

### SUMMARY THE INVENTION

The present invention will be described using automotive manufactures and automotive dealerships as an example, but the invention is not limited thereto.

Unlike today's traditional offerings, the present invention is a highly compelling new digital engagement tool for automotive dealerships, by way of example only, that leverages virtual technology designed to address today's car shopper demands, including their insatiable thirst for details about car makes, models, trims and options.

With the average number of dealerships visited by car buyers in decline, dealerships look to further drive website visits and lead generation; and ultimately establish, secure and reinforce brand relationships with their customers and prospects.

In short, with fewer actual dealership visits, today's dealership must be able to deliver the “next best thing to being there.”

While there is certainly no shortage of car photography or videos featuring inventory across the worldwide web; the ability to provide car shoppers with an opportunity to virtually “walk around,” “open the hood”, or “sit inside” a vehicle from his or her living room by way of a “virtually immersive experience” is both new and exciting.

The sharp contrast between experiencing inventory featured in website photos or videos versus the excitement of the present invention's state-of-the-art virtual reality experience is what unmistakably retains shopper attention.

Whether experienced on a mobile phone, PC, a tablet or pair of virtual goggles, the experience provided by the present invention is enhanced by its substantially richer visual experience, interactivity, and its unique self-navigational nature.

With the present invention, the user is in control, easily toggling in any direction, actively exploring different views, details and features of a particular vehicle of interest—while calling up additional information on demand throughout the journey.

The kinesthetically-driven nature of the virtual experience, coupled with the advantage of self-navigation renders the visit so engaging that the user invariably remains online longer, revealing deeper insights about his or her particular interests.

The present invention's powerful virtual technology enables car shoppers to experience exciting, self-guided and/or virtual tours of a vehicle's exterior and interior, offering an immersive experience so real that it's the next best thing to being there.

Embedded in each experience are highly informative overlay displays that appear onscreen with a click, coupled with short, easy-to-consume voice-overs providing only the most salient vehicle data on demand.

The present invention offers real and intelligent virtual onscreen assistants that can be summoned instantly to answer questions on the fly, or engage in detailed exchanges about a model's particular features and benefits.

Importantly, the prevent invention's solution is imbedded in the dealership's website, and/or is made accessible through the use of Quick Response (QR) codes, thus enabling a shopper to toggle between the virtual experience itself and the website for supplemental information.

Thus, the shopper remains on the dealership site at all times, safeguarding each and every lead.

Once the shopper makes a buy selection, the system of the present invention invites the shopper on an exciting dynamic virtual visit of the dealership, allowing the dealer to showcase clean well-lit showrooms, service bays, part stores, and financing departments, emphasizing a diversity of service offerings.

Like its virtual car experiences, present invention's virtual dealership visits are equally immersive and engaging, populated by real or virtual assistants to help guide shoppers as needed, allowing dealers to build strong relationships between their brands and their soon-to-be loyal customers.

While the present invention can be is integrated into a dealership's website, it's highly appealing content can be actively repurposed for use in targeted email campaigns or display ads to attract and entice shoppers to the site.

Following a virtual visit, Dealer XR's 24/7 Connectivity feature enables its intuitive virtual assistants to further engage in automated email relationships with shoppers, deepening brand relationships with its now valuable qualified leads. Dealer XR's intuitive email technology generates persuasive schedule-sensitive natural language emails that ultimately advance each lead to the dealer physical showroom floor, ultimately facilitating the close.

The present inventions connectivity interacts with a dealer's new and repeat customers, engaging new customer sales leads up to 180 days.

With the invention's connectivity one can keep the conversation going to have customers coming back to your dealership after the sale.

Stay top of mind throughout your customer's complete lifecycle from car sales to parts and service maintenance, while securing lifetime loyalty.

All car shopper interactions using the present inventions, including the highly engaging interactive virtual walk-arounds, virtual dealer visits, as well as the virtually-assisted and automated natural language email exchanges are carefully tracked by our analytics software designed to continuously improve campaign outcomes and dealership return on investment.

With the analytics data made possible by the present invention, a dealer will be able to better understand the specific interests, needs and overall behavior of today's evolving car shoppers, as the solution contributes valuable insights for maximizing your car sales and after-sale car parts and services.

Use of the present invention also adds to the user's search engine optimization efforts thought the use of unique code/text design.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which.

FIG. 1 is a chart identifying primary and secondary motivations of a potential automobile purchaser;

FIG. 2 is a block diagram of one embodiment of a control system for the present invention;

FIG. 3 is a continuation of the block diagram illustrated in FIG. 2;

FIG. 4 is a flow chart illustrating the operation of the present invention, and

FIG. 5 is a continuation of the block diagram illustrated in FIG. 2.

### DESCRIPTION OF THE PREFERRED EMBODIMENT

An example embodiment of the present invention will now be described with reference to the accompanying drawings.

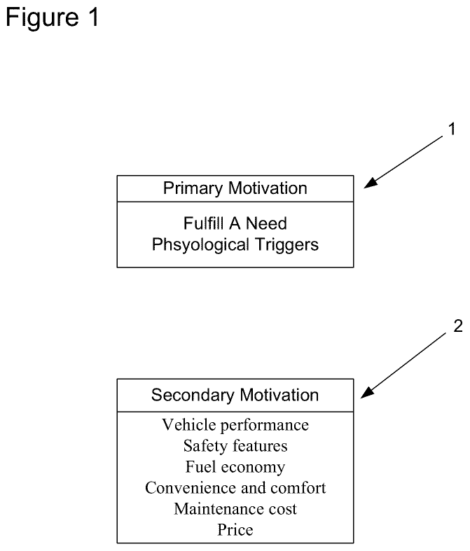

Making a purchase decision begins with motivation. As FIG. 1 illustrates, there are Primary Motivations 1 and Secondary Motivations 2 that typically drive purchasing decisions. Primary motivations are usually the same for all purchase decisions, i.e., the desire to fulfill a need and/or motivation resulting from a physiological trigger. Such physiological triggers can be based on the need to impress others by making a costly purchase, self-fulfillment or for some other reason having nothing to do with an actual need for the item being purchased.

Secondary Motivation 2 is directed to which item to buy from among a plurality of items in the same product category. As FIG. 1 illustrates, with respect the purchase of vehicle, secondary motivations often include considerations of: (1) vehicle performance, (2) safety features, (3) fuel economy, (4) convenience and comfort; (5) maintenance cost; and (6) price.

Once a buyer's primary and secondary motions are understood, an interactive presentation in accordance with the present invention can automatically constructed for that particular buyer.

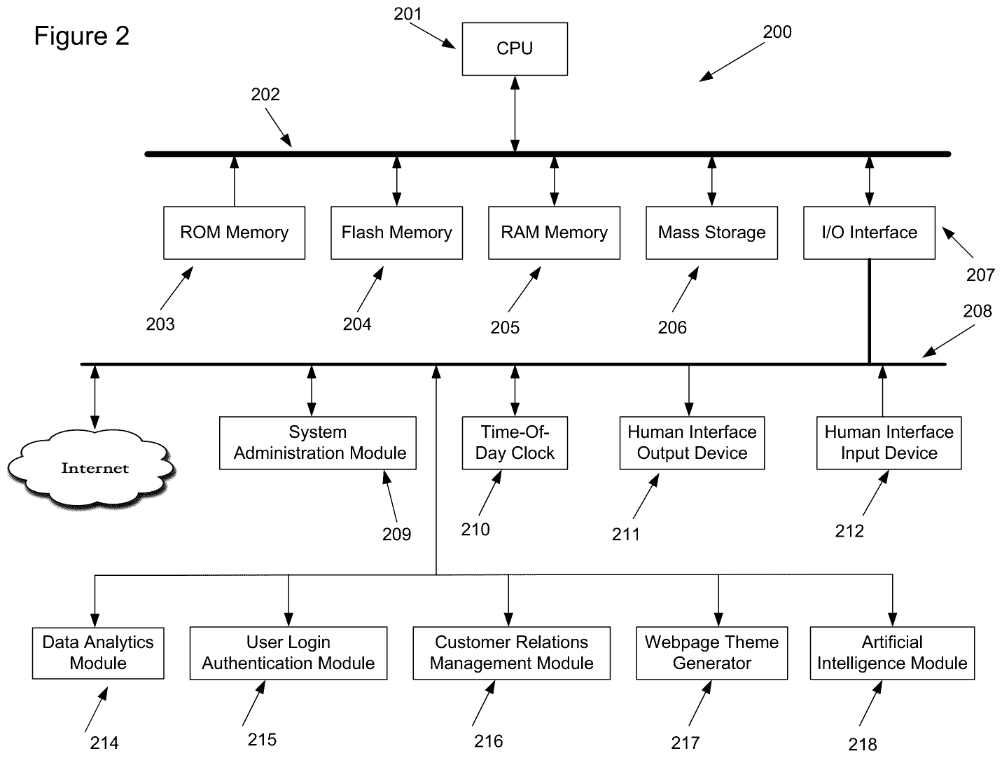

FIG. 2 is an overall block diagram of one embodiment of an interactive presentation system 200 in accordance with the present invention.

The system includes Central Processing Unit (CPU) 201 which is used to execute computer software instructions as is known in the art. CPU 201 is coupled, via buss 202, to ROM Memory 203, Flash Memory 204, RAM Memory 205, Mass Storage 206 and I/O Interface 207.

ROM Memory 203 and Flash Memory 204 may be used to store computer software instructions for execution by CPU 201. RAM memory 205 may also be used for storing computer software instructions, and especially for storing information that is only needed for a short period of time. Mass Storage 206 is used for longer and larger data storage needs as may be required to retain dealer and customer data over time. The above recited elements may be implemented as a webserver on the Internet or may be in the form of computer device connected to the Internet.

I/O Interface 207 allows the system of the present invention to communicate via buss 208 to other parts of the system, such System Administration Module 209, Time-Of-Day Clock 210, Human Interface Output Device 211, Human Interface Input Device 212, Data Analytics Module 214, User Login Authentication Module 215 and Customer Relations Management Module 216, Webpage Theme Generator 217 and Artificial Intelligence Module 218.

As shown in FIG. 2, System 200 is connected to the Internet via Bus 208

Human Interface Output Device 211 and Human Interface Input Device 212 permit a system administrator to administer the system using System Administration Module 209.

The present invention also includes a smart device or desktop PC app that runs on a customer device to better enable the system of the invention and the customer to better engage.

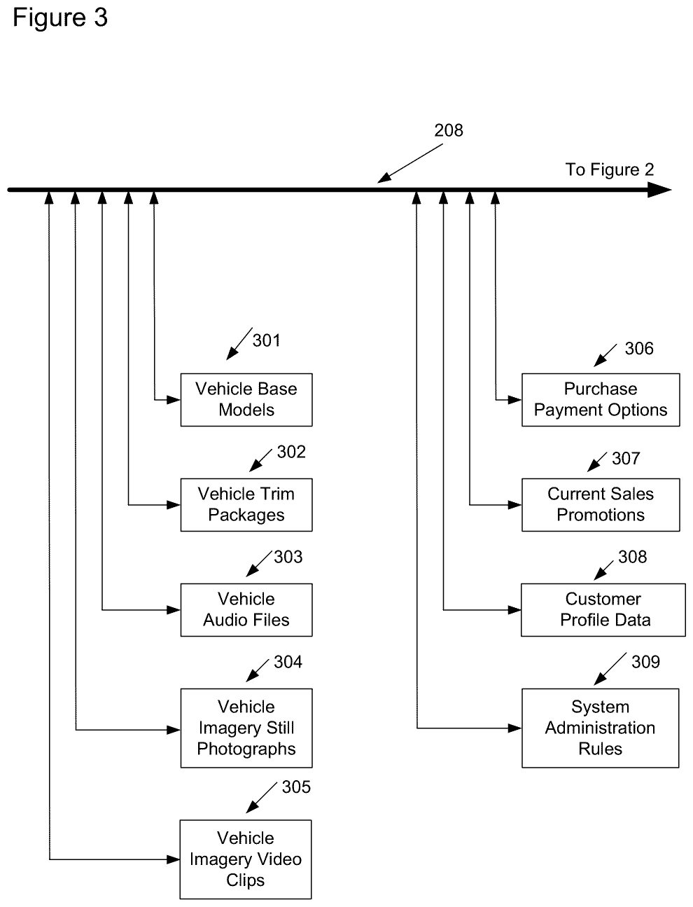

Mass Storage 206 may be formed of a plurality of databases as shown in FIG. 3.

Database 301 stores a plurality of vehicle base models that a buyer may choose form. Database 302 stores the various trim packages that are available for the various base models. Database 303 contains audio files that the system of the invention uses. Database 304 contains vehicle imagery still photographs that the system of the invention uses. Database 305 contains vehicle imagery video clips that the system of the invention uses. Database 306 contains purchase options, such as discounts for cash payments, installment loan arrangements, vehicle lease terms and the like. Database 307 contains current sales promotions. Database 308 contains customer profile data, some of which may be gleamed from publically available source, purchased from private sources or provided by the buyer. Database 309 contains system administration rules which determine how the system operates in various situations.

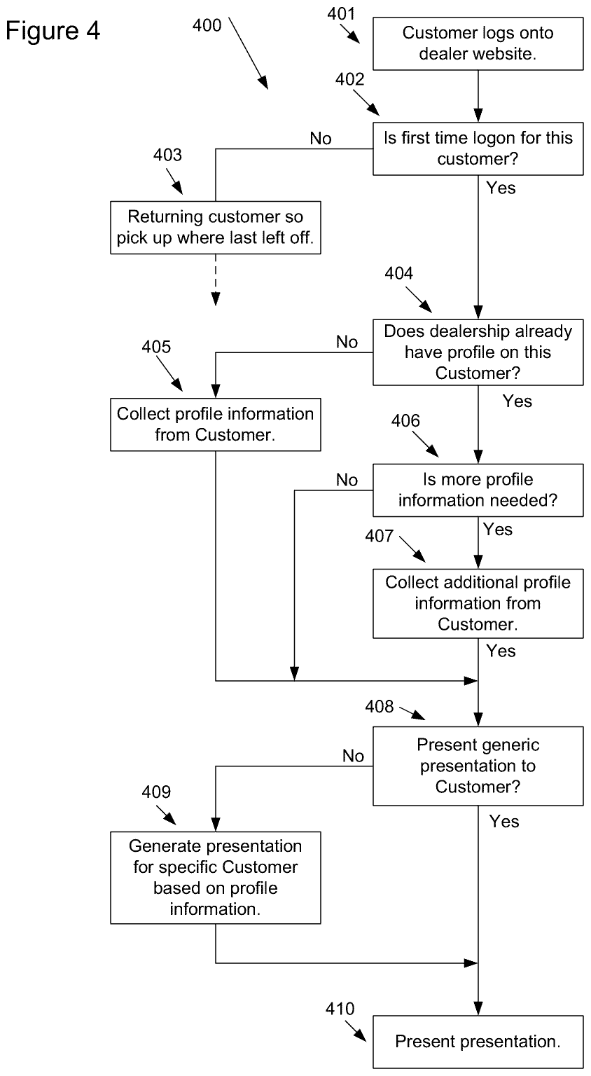

FIG. 4 is a flow chart illustrating one embodiment of the operation of the present invention.

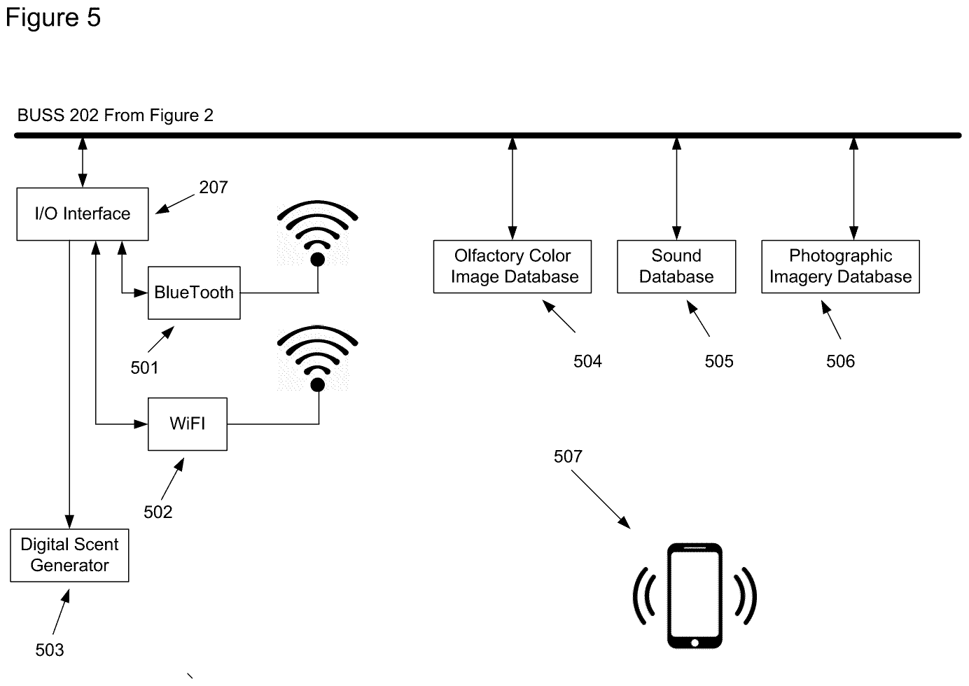

FIG. 5 is an extension of the block diagram shown in FIG. 2 with respect to Buss 202 and I/O Interface 207.

As shown in FIG. 5, Bluetooth module 501 and WiFi module 502 allow the system of the invention to communicate with, for example, cell phone or smart device 507. In one embodiment of the invention, a software app running on the smart device will allow a user of the system to interface with it using the smart device. Other devices may be used as well, such as, for example, a PC, laptop or tablet computer.

Also coupled to I/O Interface 207 is Digital Scent Generator 503.

Science has recognized more than 20 distinct human body senses. The five most well-known are the sense of touch, taste, smell, sound, and sight. Ours senses are used to collect information about the environment and send that information through receptor cells to our brain using our nervous system. It is our senses that help us to understand and perceive the world around us. In most cases, the combination of two or more of our senses help to form our perceptions. This condition is known as synaesthesia and describes how our senses work together. For example, we taste food using both the sense of taste and the sense of smell.

In a virtual reality model, it is important to capture and communicate as many of the body's senses as possible in order to achieve a sense of presence for the user. The sense of smell plays a vital role in achieving this sense of presence. Thus, the interactive presentation system of the present invention includes a Digital Scent Generator 503. Such devices are currently known in the art. For example, if the presentation is centered around a new car, Generator 503 will produce the smell of a new car when controlled by CPU 201 (FIG. 2) to do so. Generator 503 may be embedded in smart device 507 such as a cell phone or other such device.

With respect to the sense of sight, particular colors also trigger other sensations. For example, the color green can evoke the smell of grass; the color yellow can evoke a sour smell or taste; and the color pink can evoke a fruity smell or taste. Thus, the intelligent selection of colors schemes in a presentation, or avoiding certain color schemes, can add to the sense of presence for the user.

Accordingly, the system of the present invention includes Olfactory Color Image Database 504 which is used to store a plurality of color palettes that can be drawn from depending on the nature of the presentation and the mode that the presentation desires to achieve.

Sound Database 505 and Photographic Imagery Database 506 are also provided which contain sound and photographic media clip that can be drawn from as desired for the presentation.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A device for delivering an electronic interactive presentation to a user, said device comprising:
a central processing unit (CPU) for executing a computer program;
a memory module coupled to said CPU for storing said computer program and related data;
a database coupled to CPU for storing data to be retrieved by said CPU for presentation to a user of said device upon request by the user; and
an input device coupled to said CPU for the user to make said request.
